(19) United States
(12) Patent Application Publication
(10) Pub. No.: US 2024/0017789 A1
(43) Pub. Date: Jan. 18, 2024

(54) SWINGARM ASSEMBLY, VEHICLE INCLUDING A SWINGARM ASSEMBLY, AND METHOD OF MANUFACTURING A SWINGARM ASSEMBLY

(71) Applicant: Zero Motorcycles, Inc., Scotts Valley, CA (US)

(72) Inventors: Tim L. Behrman, Santa Cruz, CA (US); Kevin Waggoner, Scotts Valley, CA (US)

(21) Appl. No.: 18/351,145

(22) Filed: Jul. 12, 2023

Related U.S. Application Data
(60) Provisional application No. 63/389,110, filed on Jul. 14, 2022.

(51) Int. Cl. B62K 25/28; B22D 21/04

(52) U.S. Cl. CPC B62K 25/283; B22D 21/04

(57) ABSTRACT

A swingarm assembly for a two-wheel vehicle includes: a swingarm body including first and second side arms extending in a longitudinal direction and a transverse cross member connected to the first and second side arms, each side arm having a C-shaped cross-section open toward an outer lateral side; and covers attached to the outer lateral sides of the first and second side arms and extending in the longitudinal direction, the covers enclosing at least a portion of the C-shaped cross-section to form enclosed cavities delimited by an inner surface of the side arm and an inner surface of the cover.

### CROSS-REFERENCE TO RELATED APPLICATIONS

This application claims the benefit of U.S. Provisional Patent Application No. 63/389,110, filed on Jul. 14, 2022, the entire contents of which are hereby incorporated herein by reference.

### FIELD OF THE INVENTION

The present invention relates to a swingarm assembly, a vehicle including a swingarm assembly, and a method of manufacturing a swingarm assembly.

### BACKGROUND INFORMATION

Soft tail motorcycles include a rear suspension having a swingarm pivotably connected to a rigid frame of the motorcycle to provide a smoother ride than a hard tail motorcycle. The front end of the swingarm can pivot about an axis at the point of attachment of the swingarm to the frame, and the rear wheel of the motorcycle is connected to the rear end of the swingarm. One or more shock absorbers are provided between the swingarm and the frame to further enhance the riding comfort.

The swingarm should satisfy certain requirements of, for example, high strength, high rigidity, and low weight and should be readily manufactured in a cost-effective manner.

### SUMMARY

According to an example embodiment of the present invention, a swingarm assembly for a two-wheel vehicle includes: a swingarm body including first and second side arms extending in a longitudinal direction and a transverse cross member connected to the first and second side arms, each side arm having a C-shaped cross-section open toward an outer lateral side; a first cover attached to the outer lateral side of the first side arm and extending in the longitudinal direction, the first cover enclosing at least a portion of the C-shaped cross-section to form an enclosed first cavity delimited by an inner surface of the first side arm and an inner surface of the first cover;

and a second cover attached to the outer lateral side of the second side arm and extending in the longitudinal direction, the second cover enclosing at least a portion of the C-shaped cross-section to form an enclosed second cavity delimited by an inner surface of the second side arm and an inner surface of the second cover.

According to an example embodiment of the present invention, a two-wheel vehicle includes a frame; and a swingarm assembly pivotably connected to the frame. The swingarm assembly includes: a swingarm body including first and second side arms extending in a longitudinal direction and a transverse cross member connected to the first and second side arms, each side arm having a C-shaped cross-section open toward an outer lateral side; a first cover attached to the outer lateral side of the first side arm and extending in the longitudinal direction, the first cover enclosing at least a portion of the C-shaped cross-section to form an enclosed first cavity delimited by an inner surface of the first side arm and an inner surface of the first cover; and a second cover attached to the outer lateral side of the second side arm and extending in the longitudinal direction, the second cover enclosing at least a portion of the C-shaped cross-section to form an enclosed second cavity delimited by an inner surface of the second side arm and an inner surface of the second cover.

According to an example embodiment of the present invention, a method of manufacturing a swingarm assembly for a two-wheel vehicle includes: casting, by permanent mold casting, a swingarm body including first and second side arms extending in a longitudinal direction and a transverse cross member connected to the first and second side arms, each side arm having a C-shaped cross-section open toward an outer lateral side; attaching a first cover to the outer lateral side of the first side arm, the first cover extending in the longitudinal direction and enclosing at least a portion of the C-shaped cross-section to form an enclosed first cavity delimited by an inner surface of the first side arm and an inner surface of the first cover; and attaching a second cover to the outer lateral side of the second side arm, the second cover extending in the longitudinal direction and enclosing at least a portion of the C-shaped cross-section to form an enclosed second cavity delimited by an inner surface of the second side arm and an inner surface of the second cover.

The cross member may be arranged as an open boxed-shaped cross member.

The swingarm body may be arranged as an integral cast component.

The swingarm body may be arranged as a permanent mold cast component.

The swingarm body may be formed of an aluminum alloy.

The swingarm body may be of an A356-T6 aluminum alloy.

The first and second side arms may include stiffening ribs arranged in the cavity.

The ribs may be integral to the first and second side arms.

Each of the first and second side arms may include a lug arranged at a first longitudinal end and adapted to mount the swingarm body to a frame of the vehicle.

Each of the first and second side arms may include a wheel mount arranged at a second longitudinal end and adapted to mount a wheel of the vehicle to the swingarm.

Each of the first and second side arms may include a wheel mount arranged at a second longitudinal end located opposite the first longitudinal end and adapted to mount a wheel of the vehicle to the swingarm.

The cross member may include a boss adapted to attach the swingarm body to a shock absorber of the vehicle.

The first and second covers may be arranged as structural components of the swingarm assembly.

The first and second covers may be arranged as non-structural components of the swingarm assembly.

The first and second covers may be formed of an aluminum alloy.

The first and second covers may be formed of an ADC3 aluminum alloy.

The first and second covers may be formed of a plastic material.

The first and second covers may be permanently-connected to the swingarm body.

Further features and aspects of example embodiments of the present invention are described in more detail below with reference to the appended schematic Figures.

### BRIEF DESCRIPTION OF THE DRAWINGS

FIG. 1 is a perspective view of a swingarm assembly according to an example embodiment of the present invention.

FIG. 2 is a partial cross-sectional perspective view of a swingarm body of the swingarm assembly.

FIG. 3 is a perspective view of a swingarm body according to an example embodiment of the present invention.

FIG. 4 is a perspective view of a vehicle according to an example embodiment of the present invention.

### DETAILED DESCRIPTION

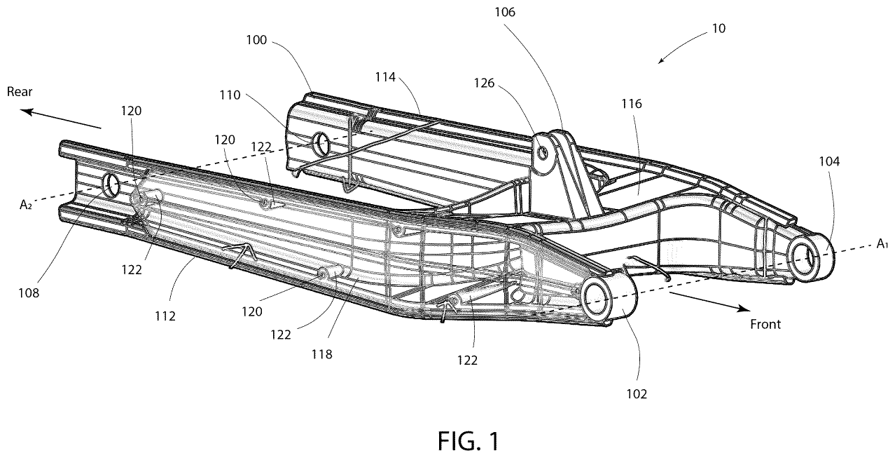

FIG. 1 is a perspective view of a swingarm assembly 10 according to an example embodiment of the present invention. As illustrated in FIG. 1, the swingarm assembly 10 includes a swingarm body 100. The swingarm body 100 includes a first side arm 112 and a second side arm 114 extending in a longitudinal direction between the front and rear ends of the swingarm 100. The side arms 112, 114 are connected to each other by a transverse cross member 116. The swingarm body 100 is adapted to pivotably mount, for example, the rear wheel of a motorcycle to the frame of the motorcycle. As illustrated in FIG. 1, the forward end of swingarm body 100 is oriented toward the front of the motorcycle, and the rear end of swingarm body 100 is oriented toward the rear of the motorcycle.

A first lug 102 is arranged at the forward end of the first side arm 112, and a second lug 104 is arranged at the forward end of the second side arm 114. The swingarm body 100 is mounted to the frame of the motorcycle via lugs 102, 104. For example, a bushing and/or bearing is provided in each lug 102, 104, and a shaft, or a pair of shafts, passes through the bushings and the frame, such that the swingarm body 100 is pivotable relative to the frame about an axis A₁ that passes through lugs 102, 104. A spacer may be provided between the lugs 102, 104 to avoid deforming the forward ends of side arms 112, 114.

A first wheel mount 108 is arranged at the rearward end of the first side arm 112, and a second wheel mount 110 is arranged at the rearward end of the second side arm 114. The axle of the rear wheel of the motorcycle is mounted to the swingarm body 100 at the wheel mounts 108, 110, and the rear wheel is rotatable about axis A₂. While wheel mounts 108, 110 are illustrated in FIG. 1 as including circular holes, it should be appreciated the wheel mounts 108, 110 may include elongated slots for mounting the rear wheel axle in a manner that permits adjustment of the location of the axle, and rear wheel, in the longitudinal direction, e.g., the forward-rearward direction.

A boss 106 is provided at the cross member 116 to mount the swingarm body 100 to a shock absorber, e.g., a hydraulic shock absorber, and coil compression spring, e.g., coil-over spring, of the motorcycle. For example, the boss 106 may be screw-connected to the shock absorber at mounting hole 126. More than one boss 106 may be included to connect to multiple shock absorbers and coil-over springs.

The swingarm body 100 may be manufactured as a single piece by permanent mold casting techniques, which utilize a reusable mold, e.g., a permanent mold. and which use gravity to fill the cavity of the reusable mold with molten metal. For example, the swingarm body 100 may be formed of an aluminum alloy, e.g., A356-T6, casting.

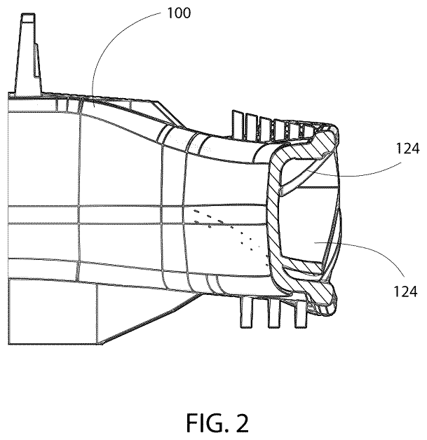

As illustrated in FIG. 1, the side arms 112, 114 may have a generally C-shaped cross section that open toward the outward lateral sides of the swingarm body 100, and the cross member 116 of the swingarm body 100 may be arranged as a hollow or open box-shaped section that transitions between each side arm 112, 114. FIG. 2 is a partial cross-sectional perspective view of swingarm body 100, illustrated the C-shaped cross section of the side arms 112, 114.

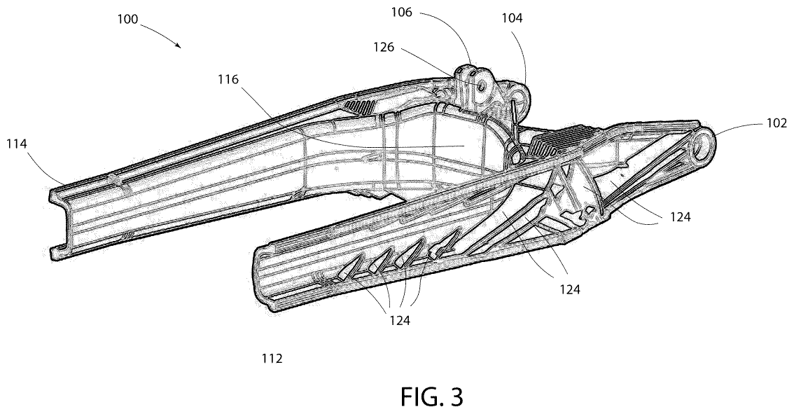

As illustrated in FIG. 2, and also illustrated in FIG. 3, which is a perspective view of swingarm body 100, ribs 124 may be provided in the side cavities of side arms 112, 114. The ribs 124 are sized and positioned to provide addition stiffness and strength to the side arms 112, 114. The ribs 124 are integrally molded with the swingarm body 100 as part of the permanent mold casting process described above.

Referring again to FIG. 1, the swingarm assembly 10 also includes a cover 118 provided on each side arm 112, 114. The cover 118 conforms to the outer side geometry of the side arms 112, 114 and may make the swingarm assembly 100 appear to be a single solid component rather than assembly of swingarm body 100 and covers 118. The covers 118 may be formed of a die cast aluminum alloy, e.g., ADC3. The covers 118 may be permanently connected to the side arms 112, 114, e.g., by rivets, deformed-head fasteners, adhesive, epoxy, or chemical bonding, welding, brazing, etc. The covers 118 may be connected, e.g., detachably connected, to the side arms 112, 114 by screws or bolts 120 that are screwed into threaded bores 122 that are integrally molded with the swingarm body 100 as part of the permanent mold casting process and threaded after the molding process. The mating surfaces of side arms 112, 114 and covers 118 may be precisely machined so that dirt, liquids, other contaminants, etc., are prevented from entering the cavity delimited by the side arms 112, 114 and covers 118. To further prevent contaminants from entering that cavity, a seal, gasket, sealant, compound, etc., may be provided between the mating surfaces of side arms 112, 114 and covers 118. In certain implementations, the covers 118 are structural components of the swingarm assembly 110 and are adapted to provide strength and rigidity to the swingarm assembly 100. Thus, the covers 118 and side arms 112, 114 form elongated, enclosed, and hollow structures but do not require complex and expensive, e.g., internal sand core casting, manufacturing techniques. In other implementations where added strength and rigidity of a structural cover 118 is not necessary, the covers 118 may be non-structural, e.g., formed of a plastic material.

Each cover 118 is attached to the outer lateral side of a respective one of the side arms 112, 114 and extends in the longitudinal direction, e.g., the frontward and rearward direction. The cover 118 encloses at least a portion of the C-shaped cross-section of the side arms 112, 114 to form an enclosed cavity delimited by an inner surface of the side arm 112, 114 and an inner surface of the cover 118.

As noted above, the swingarm body 100 may be manufactured utilizing permanent mold casting techniques. In casting the swingarm body 100, a permanent mold is preheated to facilitate flow of molten metal and also to reduce thermal shock to the mold when the mold is filled with molten metal. A refractory material or mold wash may be applied to the mold cavity to, for example, prevent the cast swingarm body 100 from sticking to the mold and prolong the life of the mold. The mold may be formed of multiple sections, including, for example, left- and right-side sections to form the C-shaped cross-sections and ribs of the side arms 112, 114 and box-shaped cross member 116 and top and bottom sections to form the facing walls of the side arms 112, 114, the boss 106, etc. Molten metal is delivered into the mold cavity using, for example, a gravity feed system, and once the metal solidifies, the mold is opened and the cast swingarm body 100 is ejected from the mold. The swingarm body 100 may be subject to finish machining, including tapping the bores 122 to receive screws 120, machining the mating surface for cover 118, and surface finishing, e.g., sand blasting, anodizing, powder coating, painting, etc.

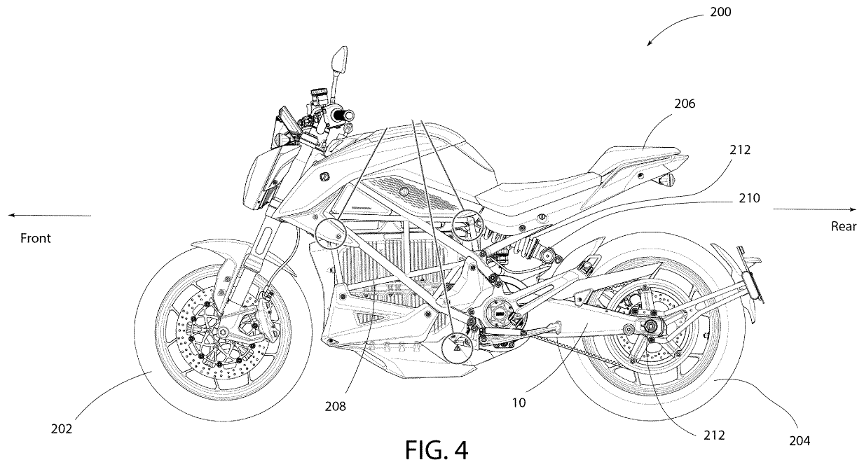

FIG. 4 is a side view of a vehicle 200 according to an example embodiment of the present invention. The vehicle 200 is arranged, for example, as an electric motorcycle powered by an energy storage device, e.g., a battery, and driven by an electric motor by a driver. The vehicle 200 includes a front wheel 202, a rear wheel 204, driven by the electric motor, and a seat 206 for accommodating a driver and, optionally, a passenger. The vehicle 200 includes a frame 208 and a shock absorber 210 and spring 212 connected to the frame 208. The vehicle 200 includes swingarm assembly 10 connected to the frame 208 via lugs 102, 104, connected to the shock absorber 210 and spring 212 via boss 106, and connected to the rear axle 214 of rear wheel 204 via wheel mounts 108, 110. While the vehicle 200 is described as an electric motorcycle, it should be appreciated that vehicle 200 may be arranged as a two-wheel vehicle, e.g., a motorcycle, scooter, e-bike, etc. and may be powered by an internal combustion engine instead of an electric motor.

### LIST OF REFERENCE CHARACTERS

10 swingarm assembly
100 swingarm body
102 lug
104 lug
106 boss
108 wheel mount
110 wheel mount
112 arm
114 arm
116 cross member
118 cover
120 screw
122 threaded bore
124 rib
126 mounting hole
200 vehicle
202 front wheel
204 rear wheel
206 seat
208 frame
210 shock absorber
212 spring
214 rear axle
A₁ pivot axis
A₂ wheel axis

What is claimed is:

1. A swingarm assembly for a two-wheel vehicle, comprising:
a swingarm body including first and second side arms extending in a longitudinal direction and a transverse cross member connected to the first and second side arms, each side arm having a C-shaped cross-section open toward an outer lateral side;
a first cover attached to the outer lateral side of the first side arm and extending in the longitudinal direction, the first cover enclosing at least a portion of the C-shaped cross-section to form an enclosed first cavity delimited by an inner surface of the first side arm and an inner surface of the first cover; and
a second cover attached to the outer lateral side of the second side arm and extending in the longitudinal direction, the second cover enclosing at least a portion of the C-shaped cross-section to form an enclosed second cavity delimited by an inner surface of the second side arm and an inner surface of the second cover.

2. The swingarm assembly according to claim 1, wherein the cross member is arranged as an open boxed-shaped cross member.

3. The swingarm assembly according to claim 1, wherein the swingarm body is arranged as an integral cast component.

4. The swingarm assembly according to claim 1, wherein the swingarm body is arranged as a permanent mold cast component.

5. The swingarm assembly according to claim 1, wherein the swingarm body is formed of an aluminum alloy.

6. The swingarm assembly according to claim 1, wherein the swingarm body is formed of an A356-T6 aluminum alloy.

7. The swingarm assembly according to claim 1, wherein the first and second side arms include stiffening ribs arranged in the cavity.

8. The swingarm assembly according to claim 7, wherein the ribs are integral to the first and second side arms.

9. The swingarm assembly according to claim 1, wherein each of the first and second side arms includes a lug arranged at a first longitudinal end and adapted to mount the swingarm body to a frame of the vehicle.

10. The swingarm assembly according to claim 1, wherein each of the first and second side arms includes a wheel mount arranged at a second longitudinal end and adapted to mount a wheel of the vehicle to the swingarm.

11. The swingarm assembly according to claim 9, wherein each of the first and second side arms includes a wheel mount arranged at a second longitudinal end located opposite the first longitudinal end and adapted to mount a wheel of the vehicle to the swingarm.

12. The swingarm assembly according to claim 1, wherein the cross member includes a boss adapted to attach the swingarm body to a shock absorber of the vehicle.

13. The swingarm assembly according to claim 1, wherein the first and second covers are arranged as structural components of the swingarm assembly.

14. The swingarm assembly according to claim 1, wherein the first and second covers are arranged as non-structural components of the swingarm assembly.

15. The swingarm assembly according to claim 13, wherein the first and second covers are formed of an aluminum alloy.

16. The swingarm assembly according to claim 13, wherein the first and second covers are formed of an ADC3 aluminum alloy.

17. The swingarm assembly according to claim 14, wherein the first and second covers are formed of a plastic material.

18. The swingarm assembly according to claim 1, wherein the first and second covers are permanently-connected to the swingarm body.

19. A two-wheel vehicle, comprising:
a frame; and
a swingarm assembly pivotably connected to the frame and including:
a swingarm body including first and second side arms extending in a longitudinal direction and a transverse cross member connected to the first and second side arms, each side arm having a C-shaped cross-section open toward an outer lateral side;
a first cover attached to the outer lateral side of the first side arm and extending in the longitudinal direction, the first cover enclosing at least a portion of the C-shaped cross-section to form an enclosed first cavity delimited by an inner surface of the first side arm and an inner surface of the first cover; and
a second cover attached to the outer lateral side of the second side arm and extending in the longitudinal direction, the second cover enclosing at least a portion of the C-shaped cross-section to form an enclosed second cavity delimited by an inner surface of the second side arm and an inner surface of the second cover.

20. A method of manufacturing a swingarm assembly for a two-wheel vehicle, comprising:
casting, by permanent mold casting, a swingarm body including first and second side arms extending in a longitudinal direction and a transverse cross member connected to the first and second side arms, each side arm having a C-shaped cross-section open toward an outer lateral side;
attaching a first cover to the outer lateral side of the first side arm, the first cover extending in the longitudinal direction and enclosing at least a portion of the C-shaped cross-section to form an enclosed first cavity delimited by an inner surface of the first side arm and an inner surface of the first cover; and
attaching a second cover to the outer lateral side of the second side arm, the second cover extending in the longitudinal direction and enclosing at least a portion of the C-shaped cross-section to form an enclosed second cavity delimited by an inner surface of the second side arm and an inner surface of the second cover.
